(19) United States
(12) Patent Application Publication
(10) Pub. No.: US 2009/0102959 A1
(43) Pub. Date: Apr. 23, 2009

(54) IMAGE CAPTURE DEVICE AND METHOD FOR MANUFACTURING SAME

(75) Inventors: GA-LANE CHEN, Santa Clara, CA (US); CHUN-YU LEE, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/198,270

(22) Filed: Aug. 26, 2008

(30) Foreign Application Priority Data
Oct. 22, 2007 (CN) 200710202205.8

(51) Int. Cl. H04N 5/225

(52) U.S. Cl. 348/340; 348/E05.024

(57) ABSTRACT

An image capture device includes a sensor and a first lens module. The sensor includes a photoactive region. The first lens module is disposed over the sensor. The first lens module includes a substrate, a nucleating layer, and at least one lens. The nucleating layer is disposed on the substrate. The lens is disposed on the nucleating layer and aligned with the photoactive region.

### BACKGROUND

1. Technical Field

The invention relates generally to optical devices with lenses at wafer level, and more particularly to an image capture device manufactured by wafer level packaging techniques.

2. Description of Related Art

Currently, portable electronic devices such as personal digital assistants (PDAs), cellular telephones, and others, are becoming indispensable. Along with the increasingly widespread use of such devices, there is a demand for multi-functional mobile communication terminals. Accordingly, mobile communication terminals with image capture capability have been developed. In such devices, however, volume reduction is also a priority.

An image capture device proposed by Gautham Viswaradam et al. fitting inside a small mobile communication terminal generally consists of a semiconductor imaging chip, a lens assembly, and a microprocessor are assembled in a single module to meet size requirements. The miniature image capture device offers advantages such as low weight and cost that are deemed important in the market. However, it is understood that a method for fabricating the compact image capture device, in particular to mass production thereof, presents increased difficulty over that of conventional image capture devices. In addition, image capture quality is a further priority.

What is needed, therefore, is an image capture device providing improved image quality and efficiency of mass production.

### SUMMARY

An image capture device is provided. In an embodiment, the image capture device includes a sensor and a lens module. The sensor includes a photoactive region. The lens module is disposed over the sensor. The lens module includes a substrate, a nucleating layer, and at least one lens. The nucleating layer is disposed on the substrate. The lens is disposed on the nucleating layer and aligned with the photoactive region.

Advantages and novel features of the present image capture will become more apparent from the following detailed description when taken in conjunction with the accompanying drawings.

### BRIEF DESCRIPTION OF THE DRAWINGS

The components in the drawing are not necessarily drawn to scale, the emphasis instead being placed upon clearly illustrating the principles of the present invention.

FIG. 1 is a cross-section of an image capture device in accordance with a first embodiment.

FIG. 2 is a cross-section of an image capture device in accordance with a second embodiment.

FIG. 3 is a schematic view of a method for manufacturing the image capture device of FIG. 1.

FIG. 4 is a vertical view of a lens module array in accordance with the first embodiment.

Corresponding reference characters indicate corresponding parts. The exemplifications set out herein illustrate at least one preferred embodiment of the present image capture device and method for manufacturing same, in one form, and such exemplifications are not to be construed as limiting the scope of the invention in any manner.

### DETAILED DESCRIPTION OF THE EMBODIMENT

Reference will now be made to the drawings to describe embodiments of the present image capture device and method for manufacturing same in detail.

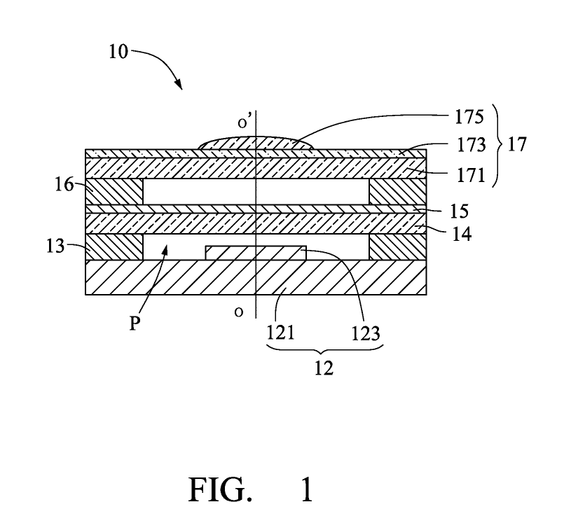

Referring to FIG. 1, an image capture device 10 in accordance with a first embodiment, is shown. The image capture device 10 includes a sensor 12, a first spacer 13, a transparent cover 14 and a first lens module 17. In the present embodiment, the image capture device 10 can be deployed in electronic devices such as notebook computers, personal digital assistants (PDAs), or cellular telephones.

In the present embodiment, the sensor 12 is a solid state sensor such as a charge-coupled device (CCD) or a complementary metal-oxide-semiconductor (CMOS). The sensor 12 includes a semiconductor substrate 121 and a photoactive region 123 thereon. The semiconductor substrate 121 comprises silicon.

The transparent cover 14 is disposed over the sensor 12. Particularly, the transparent cover 14 is spaced from the sensor 12 by a predetermined distance via the first spacer 13, which is disposed therebetween. The predetermined distance is adjustable via the first spacer 13, corresponding to a thickness thereof. The first spacer 13 is connected with the sensor 12. Particularly, the first spacer 13 is connected with the semiconductor substrate 121 and the transparent cover 14 by an adhesive such as UV curable resin, heat curable resin or other. The first spacer 13 is generally annular and cooperates with the transparent cover 14 to define a sealed space P receiving the photoactive region 123 of sensor 12. As such, the photoactive region 123 of the sensor 12 is protected from contamination by dust or environmental particles.

In the present embodiment, the transparent cover 14 can be made of transparent glass, and may further include a filter 15 disposed thereon. The filter 15 can be an infrared filter, an infrared pass filter, or others, chosen based on optical function design.

The first lens module 17, configured for converging light to the photoactive region 123, is disposed over the transparent cover 14. The first lens module 17 includes a substrate 171, a nucleating layer 173, and at least one lens 175. The nucleating layer 173 is disposed on the substrate 171. The lens 175 is disposed on the nucleating layer 173 and aligned with the photoactive region 123 of sensor 12. That is, the photoactive region 123 is positioned on an optical axis O-O′ of the lens 175. In the present embodiment, the lens 175 is plastic. In addition, the lens 175 is formed as a spherical or non-spherical lens.

The nucleating layer 173 in the present embodiment is configured to modulate surface tension occurring during manufacture of lens 175. Particularly, the nucleating layer 173 is provided to avoid excessive curvature of the formed lens 175, maintaining optical properties thereof. In addition, the nucleating layer 173 enhances adhesion force between the lens 175 and the substrate 171, resisting separation therebetween. In the present embodiment, the nucleating layer 173 is material other than that of the substrate 171 or the lens 175. Suitably, the nucleating layer 173 is transparent inorganic material, such as silicate, i.e. SiO or SiO₂, or titanium dioxide (TiO₂).

Furthermore, the image capture device 10 of the present embodiment can include a second spacer 16 between the transparent cover 14 and the first lens module 17. The second spacer 16 is generally annular and light-blocking material. Thus, the transparent cover 14 is spaced from the lens module 17 by a desired distance via the second spacer 16.

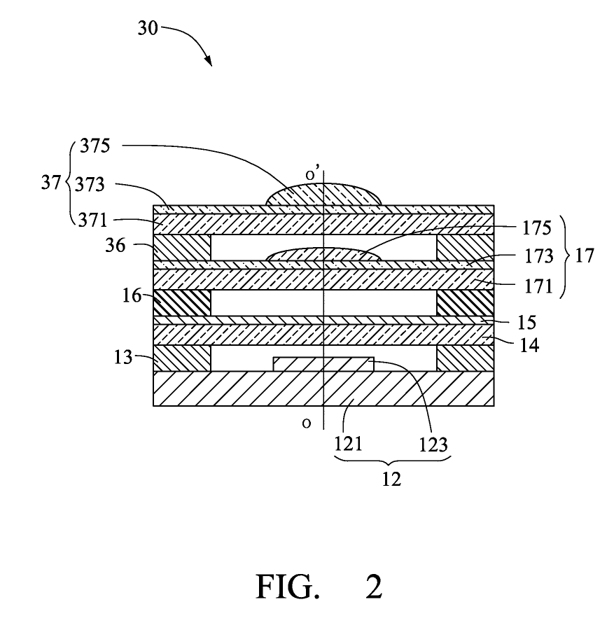

Referring to FIG. 2, an image capture device 30 in accordance with a second embodiment, is shown, differing from image capture devices 10 and 30 only in that the lens module disposed over the sensor 12 is not limited to a quantity of one. The image capture device 30 includes a second lens module 37 disposed over the first lens module 17. The second lens module 37 is similar to the first lens module 17, and thus detailed description thereof is omitted. In practice, additional lens module disposition is configured to compensate for optical aberration, which may occur if the image capture device 30 experiences vibration. In such case, the image capture device 30 can further include a third spacer 36 disposed between the second lens module 37 and the first lens module 17, allowing achievement of desired distance between the first lens module 17 and the second lens module 37.

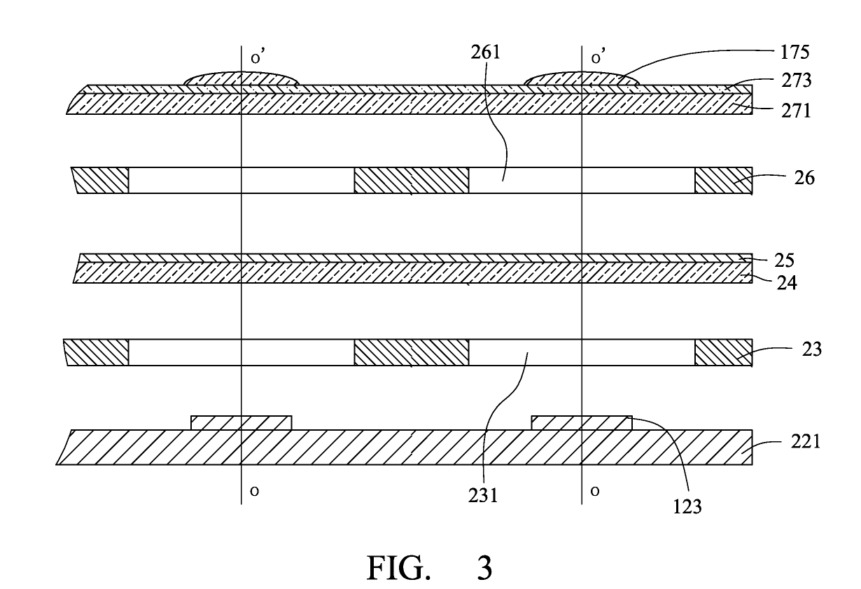

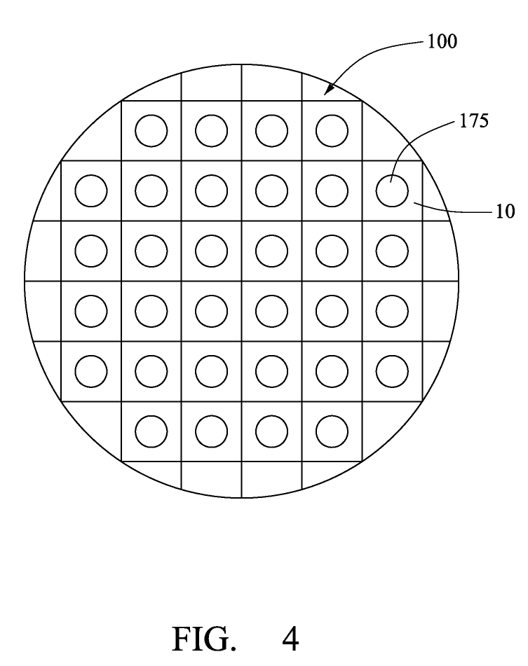

Referring to FIG. 3 and FIG. 4, a method for manufacturing an image capture device in accordance with a present embodiment includes, in step 1, providing a semiconductor wafer 221, fabricated by a semiconductor manufacturing process to define a plurality of photoactive regions 123 thereon. In the present embodiment, the semiconductor wafer 221, serving as a substrate for the photoactive regions 123 formed thereon, is a silicon wafer.

In step 2, a first spacer wafer 23, fabricated by, for example, etching, laser drilling, or ultrasonic drilling to define a plurality of first through holes 231, is provided on the semiconductor wafer 221. The first spacer wafer 23 separates a subsequently formed cover wafer 24 from the semiconductor wafer 221 by a predetermined distance. Each of the first through holes 231 is aligned with each of the photoactive regions 123.

In step 3, a transparent cover wafer 24 is provided on the first spacer wafer 23. In the present embodiment, the transparent cover wafer 24 is treated by, for example, sputtering or evaporation to form a filter 25 thereon.

In step 4, a second spacer wafer 26 defining a plurality of second through holes 261, is provided over the transparent cover wafer 24. The plurality of second through holes 261 is fabricated by, for example, etching, laser drilling, or ultrasonic drilling on the second spacer wafer 26. In addition, each of the second through holes 261 is aligned with each of the first through holes 231. Thus, each of the second through holes 261 is aligned with each of the photoactive regions 123.

In step 5, a glass wafer 271 is provided on the second spacer wafer 26. In addition, a nucleating layer 273 is deposited on the glass wafer 271 by sputtering or evaporation. Then, a plurality of lenses 175 is fabricated by embossing, such as ultraviolet, heat, or nitrogen embossing. Each of the lenses 175 is aligned with each of the photoactive regions 123.

In step 6, the semiconductor wafer 221, the first spacer wafer 23, the transparent cover wafer 24, the second wafer 26, and the glass wafer 271 on which the nucleating layer 273 and the lenses 175 are formed, are collectively assembled to form a lens module array 100. Particularly, the wafers 221, 23, 24, 26, 271 are collectively laminated via an adhesive such as UV-curable resin or heat curable resin. The lenses 175 are thus arranged in a regular pattern, aligning with the photoactive regions 123, as shown in FIG. 4. Referring to FIG. 3, each of the lenses 175 and the photoactive regions 123 are on the optical axis O-O′.

In step 7, the lens module array 100 is cut into a plurality of separated image capture devices 10, providing mass production of the image capture devices 10 with micro scale.

Finally, it is to be understood that the described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. An image capture device, comprising:
a sensor including a photoactive region; and
a first lens module disposed over the sensor, the first lens module comprising a substrate, a nucleating layer disposed on the substrate, and at least one lens disposed on the nucleating layer and aligned with the photoactive region.

2. The image capture device as claimed in claim 1, further comprising a first annular spacer disposed between the sensor and the lens module.

3. The image capture device as claimed in claim 1, further comprising a transparent cover disposed between the sensor and the first lens module.

4. The image capture device as claimed in claim 3, further comprising a filter disposed on the transparent cover.

5. The image capture device as claimed in claim 3, further comprising a second annular spacer disposed between the transparent cover and the first lens module.

6. The image capture device as claimed in claim 1, wherein the substrate is glass.

7. The image capture device as claimed in claim 1, wherein the nucleating layer is transparent inorganic material of silicate or titanium dioxide.

8. The image capture device as claimed in claim 1, wherein the lens is plastic.

9. The image capture device as claimed in claim 1, further comprising a second lens module disposed over the first lens module.

10. The image capture device as claimed in claim 9, further comprising a third spacer disposed between the first lens module and the second lens module.

11. An image capture device, comprising:
a sensor including a photoactive region;
a transparent cover disposed over the sensor; and
a lens module disposed over the transparent cover, the lens module comprising a substrate, a nucleating layer disposed on the substrate, and at least one lens disposed on the nucleating layer and aligned with the photoactive region.

12. The image capture device as claimed in claim 11, further comprising a first annular spacer disposed between the sensor and the transparent cover.

13. The image capture device as claimed in claim 11, further comprising a second annular spacer disposed between the transparent cover and the lens module.

14. A method for manufacturing an image capture device, the method comprising:
providing a semiconductor wafer including a plurality of photoactive regions;
providing a glass wafer over the semiconductor wafer;
creating a nucleating layer on the glass wafer;
forming a plurality of lenses on the nucleating layer, each of the lenses aligning with the respective photoactive region, thus obtaining a lens module array; and
cutting the lens module array into a plurality of separated image capture devices.

15. The method as claimed in claim 14, wherein the nucleating layer is transparent inorganic material.

16. The method as claimed in claim 14, wherein the lenses are plastic and are formed on the nucleating layer by an embossing process.

17. The method as claimed in claim 1 6, wherein the embossing process is selected from the group consisting of ultraviolet embossing, hot embossing, and nitrogen embossing.

18. The method as claimed in claim 14, further comprising, before providing the glass wafer over the semiconductor wafer, providing a transparent cover wafer over the semiconductor wafer, wherein a filter is formed on the transparent cover wafer.

19. The method as claimed in claim 18, further comprising, before providing the transparent cover wafer over the semiconductor wafer, providing a first spacer wafer comprising a plurality of first through holes on the semiconductor wafer, each of the first through holes aligning with the respective photoactive region.

20. The method as claimed in claim 18, further comprising, after providing the transparent cover wafer over the semiconductor wafer and before providing a glass wafer over the semiconductor wafer, providing a second spacer wafer comprising a plurality of second through holes over the transparent cover wafer, each of the second through holes aligning with the respective photoactive region.
